(19) United States
(12) Patent Application Publication
(10) Pub. No.: US 2009/0019512 A1
(43) Pub. Date: Jan. 15, 2009

(54) System Method and Computer Readable Medium for Multicasting Control Messages to a Set Top Box

(75) Inventors: Christopher J. Stone, Newtown, PA (US); Richard Moore, Harleysville, PA (US); Yeqing Wang, Horsham, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/774,765

(22) Filed: Jul. 9, 2007

(51) Int. Cl. H04N 7/173

(52) U.S. Cl. 725/132

(57) ABSTRACT

A system, method and computer readable medium are disclosed that allow a set top box to receive control messages transmitted using multicasting. The set top box is programmed with either an address or a URL that it uses to obtain the control messages directly, or obtain other messages that carry the multicast address. In other implementations, a specialized offer message is transmitted to the set top box in response to a discover message. Embedded within the specialized offer message is the multicast address being used to multicast the control messages.

### FIELD OF THE INVENTION

This application relates to providing control messages to a set top box and in particular a way to provide control messages using a multicast address.

### BACKGROUND

Cable television systems provide content such as movies and music to users. A cable television system is generally comprised of three elements; a headend, a distribution network and a set top box. The headend forwards content over the distribution network to the set top boxes. The set top boxes tune, demodulate, decrypt and decode the content before it can be consumed by the user. To support this distribution of content, the headend also forwards control messages to the set top boxes. The control messages typically determine which set top box can process which piece of content. The control messages may include items such as keys for decryption, data for an Electronic Programming Guide (EPG), data for a Conditional Access System (CAS), the channel map and software updates to change the functionality or improve the performance. The content is sent through the distribution network over a set of channels. The control messages are sent over a dedicated channel called the Out-of-Band (OOB) channel. The Out-of-Band channel is one that exclusively carries control data. It does not carry content data such as video or audio. As a consequence of using an OOB channel, the set top box must have a tuner dedicated to tune to that frequency in order to receive the control messages sent on the OOB.

Another system implements Data Over Cable Services Interface Specifications (DOCSIS). A set top box that supports DOCSIS is called a DOCSIS Set Top Gateway (DSG). A DSG does allow for multicasting of control messages. However, a DSG system uses an internally defined channel or frequency to transmit those control messages down to the DSG boxes. Thus, a channel is established between the Cable Modem Termination System (CMTS) and the DSG box. Once that channel is established, the control messages can be sent using Media Access Control (MAC) addresses. This dedicated channel only transmits control messages. Thus, like the system previously described, the DSG will need a tuner dedicated to receiving the control messages transmitted on this one frequency.

While this system does provide control messages to the DSG, it still suffers from at least the problem of dedicated both a slice of bandwidth and a tuner to transmit and receive the control messages.

### BRIEF DESCRIPTION OF THE DRAWINGS

FIG. 1 shows a content distribution system that supports multicasting control messages;

FIG. 2 shows a set top box;

FIG. 3 shows another set top box;

FIG. 4 shows a method for obtaining control messages using a multicast address; and

FIG. 5 shows another method for obtaining control messages using a multicast address.

### DETAILED DESCRIPTION OF THE DRAWINGS

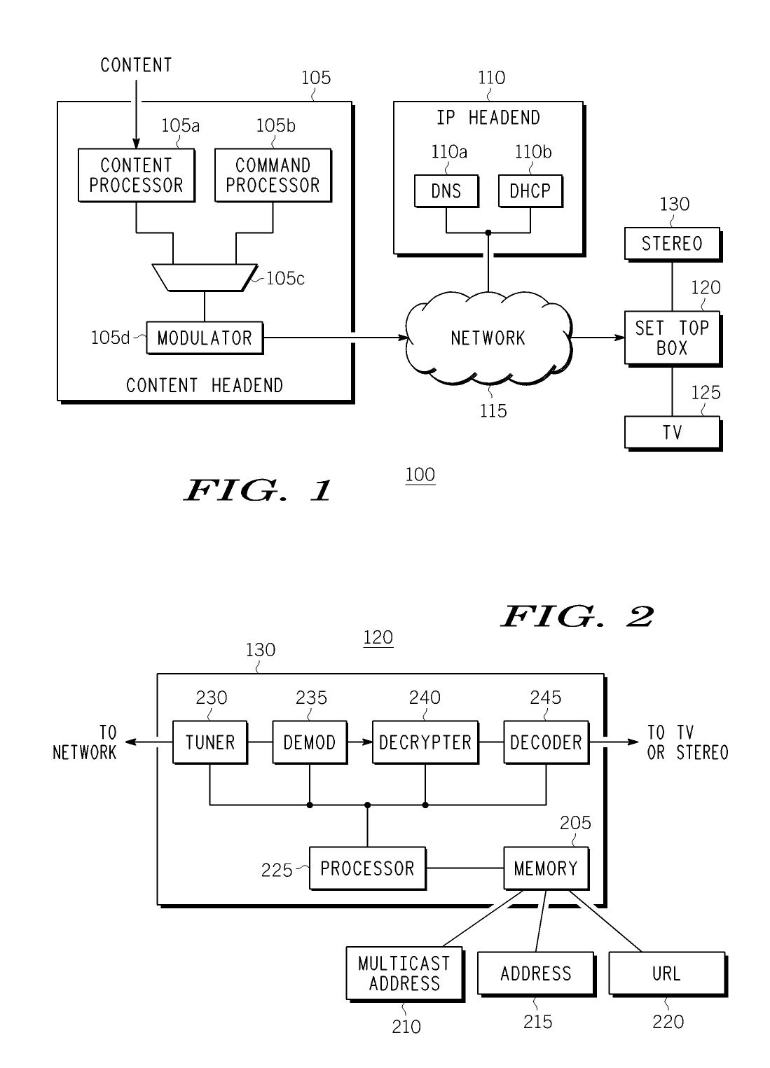

FIG. 1 shows a system 100 for distributing content and control messages. It consists of a content headend 105 that sources content and command messages to a user. System 100 also includes an IP headend 110. Both the content headend and the IP headend are coupled to a network 115. Set top box 120 communicates with the content headend 105 and the IP headend via network 115. It should be understood that while content headend 105 and IP headend 110 are shown as two separate entities in FIG. 1, they could be combined at one site in alternative implementations. Set top box 120 processes the content and forwards the processed content to either a television 125 (for video) or a stereo system 130 (for audio) for consumption by the user. It should be noted that the contents of set top box 120 could be integrated into either television 125 or stereo system 130.

Content headend includes a content processor 105a. Content processor 105a generally manipulates the content so that it is suitable for transmission through network 115. Content processor 105a typically encodes, encrypts and packetizes and addresses each packet of the content. Content headend 105 also includes a command processor 105b. Like content processor 105a, command processor 105b processes commands for transmission through network 115.

Both content processor 105a and command processor 105b output their respective packets to a multiplexer 105c. Multiplexer 105c selects which packet to output at any give point in time. Modulator 105d receives the packets from multiplexer 105d and modulates them. In one implementation, modulator 105d is a QAM modulator. The content and command data are then sent from modulator 105d through network 115 to the appropriate set top box(es).

As stated above, addresses must be added to the content and command packets. If the packet is unicast, the address is that associated with the set top box 120. Only that particular set top box receives the packet and processes it. If the packet is broadcast, then all the set top boxes coupled to network 115 will receive the packet.

If the packet is multicast, set top box 120 must first be instructed to look for packets with that multicast address.

In one implementation, set top box 120 is manufactured, or programmed before installation in the user's home, with the multicast address. Thus when content headend 105 multicasts command packets for set top box 120, set top box has the multicast address it needs to retrieve those command packets. While this system will get command packets to set top box 120, it suffers from being inflexible. That is, the MSO must always use that address in content header 105. If the MSO changes the multicast address, legacy set top boxes will not receive the necessary command packets.

To correct this short-coming, set top box 120 may instead be programmed with a different address. Set top box 120 receives packets that are addressed with this address and extracts the payload data from them. Part of this payload data will be the multicast address used to transmit command packets. Once set top box 120 has obtained the multicast address, it can receive the command packets that use are transmitted using this multicast address.

This second solution also is limited to the first address. To correct for this shortcoming, set top box 120 is programmed with a Universal Resource Locator (URL). When set top box 120 is initialized, powered on or booted-up, set top box outputs a message containing the URL.

The request is forwarded to DNS server 110a. The DNS server resolves the URL into either a) the multicast address associated with the control messages or b) or another address the set top box can use to obtain the multicast address. In either implementation, set top box 120 obtains the desired control messages thereafter by collecting packets from the multicast address.

In yet another implementation, the multicast address is sent to set top box 120 when set top box 120 requests an IP address. As stated earlier, this set top box receives data, such as video and audio content, over an IP network. Before it can receive data, the set top box must receive an IP address.

The process of obtaining an IP address includes the set top box 120 issuing a Discover message. This message is a standard message that DHCP servers understand as an announcement from set top box 120 that it is looking for an IP address. The Discover message is transmitted from set top box 120 through network 115 to DHCP server 110b in IP headend 110. DHCP server 110b responds to that Discover message with a specialized Offer message.

This Offer message contains many of the same components as other Offer messages, but it also includes the multicast address which the set top box 120 will need to receive control messages. After the set top box 120 has received its multicast address, it can receive control messages transmitted using that multicast address.

It should also be noted that some home systems that incorporate set top box 120 may have problems with this implementation. That is, a set top box behind a home router that assigns IP addresses may block or mask the control message sent using the multicast address from reaching set top box 120. This problem can be fixed, however, by having the home router forward those multicast control messages to set top box 120.

In yet another implementation set top box 120 issues a Discover message as described above. DHCP server 110b responds with a specialized Offer message. Unlike the previous implementation, this implementation inserts a URL into the Offer message. Set top box 120 receives the Offer message and extracts the URL from it. It then sends the URL to DNS server 110a which responds with the multicast address. Once set top box 120 has the multicast address, it can begin receiving multicast command messages.

FIG. 2 shows an illustrative set top box 120. Set top box 120 includes a memory 205 that may, depending on the implementation, may contain a multicast address 210, a different address 215 or a URL 220. In addition to memory 205, set top box 120 also includes a processor 225 coupled to memory 205. Processor 225 is coupled to tuner 230 that tunes to a particular frequency, a demodulator 235 that demodulates the signals on that frequency, a decrypter 240 that decrypts received content and a decoder 245 that decodes the content. Depending upon the implementation, memory 205 can be either a magnetic memory such as a hard drive or a semiconductor memory such as a RAM or ROM.

Memory 205 is shown containing one of three possible pieces of information. If set top box 120 is configured one way, memory 205 will contain a multicast address 210. In this configuration, set top box 120 will receive control messages by joining the multicast session using this address.

In another configuration, memory 205 is configured with a different address 215. Set top box 120 sends a request addressed to address 215. Set top box 120 will then receive a reply message that will include the multicast address carrying the control messages. Once set top box 120 has that multicast address, it obtains control messages using that multicast address.

In yet another configuration, memory 205 is configured with a URL 220. This URL is transmitted to the DNS server 110a where the DNS server 110a uses that address to look-up a suitable multicast address that is carrying control messages. That multicast address is then transmitted back to set top box 120 where it can be used to collect the appropriate control messages.

Once set top box 120 has the control messages, process 225 uses them to control the processing of the content. For example, a content message may include a key. Processor 225 can forward that key to decrypter 240 so that it can decrypt the content. As another example, content could be sent out on packets on different frequencies. A control message may instruct tuner 230 to tune to a particular frequency.

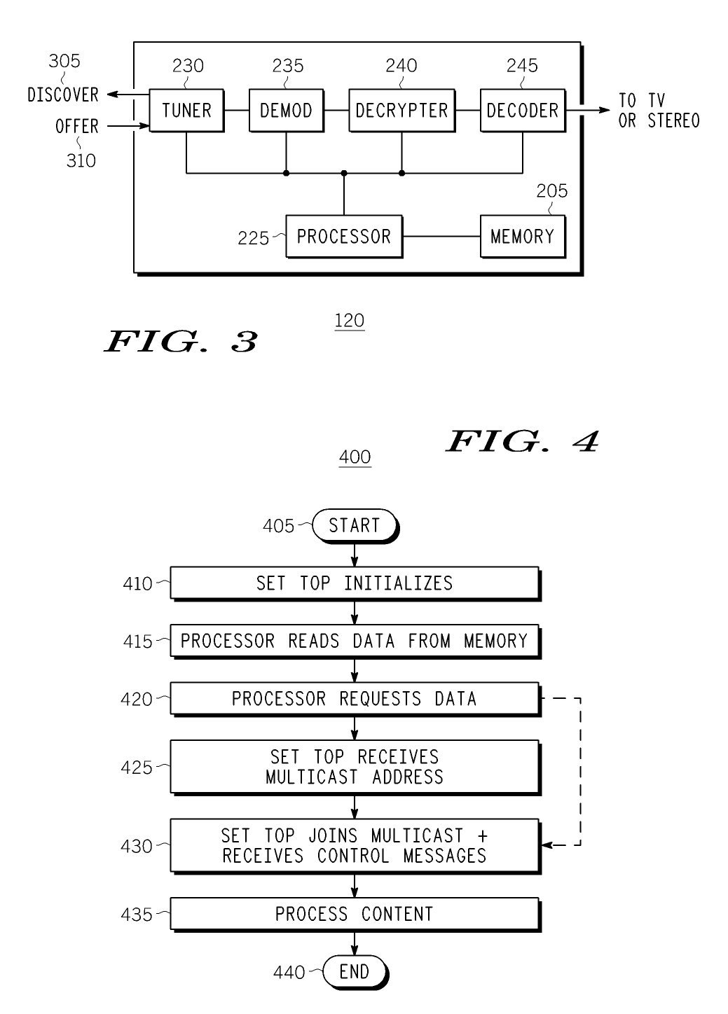

FIG. 3 shows yet another configuration for set top box 120. In this configuration, processor 225 issues a Discover message 305. The DHCP server 110b receives this Discover message 305 and responds with a Specialized Offer message 310. This specialized offer message contains the multicast address that is used to transmit the control messages.

FIG. 4 shows a method 400 for obtaining control messages using a multicast address. The process begins at step 405. At step 410, set top box 120 initializes. Typically this is a boot-up procedure that occurs when the set top box is turned on. At step 415, processor 225 reads data from memory 205. As shown in FIG. 2, this data can be a multicast address 210, a different address used to obtain a multicast address 215 or a URL 220.

Once processor 225 has the data from memory 205, it issues a request over network 115. If memory 205 holds the multicast address that is associated with transmitting control messages, then processor 210 will request to join the multicast in step 420. That is, processor 225 will receive and process packets that are transmitted with the multicast address. The process will then go to step 430 where set top box 120 joins the multicast and begins receiving command messages.

Once processor 225 has the appropriate control messages, it controls various parts of set top box 120 to process the content at step 435. As an example, the content can be decrypted as previously described. The process then ends at step 440.

If set top box 120 is configured with an address other than the multicast address associated with the control message (210) then processor 210 sends a request for information using either a different address (215) or a URL (220) at step 420. In response, the set top box 120 will receive the multicast address used in transmitting the control messages at step 425. Set top box 120 will then join the multicast at step 430 and begin receiving control message and process content using those control messages at step 435. The process then ends at step 440.

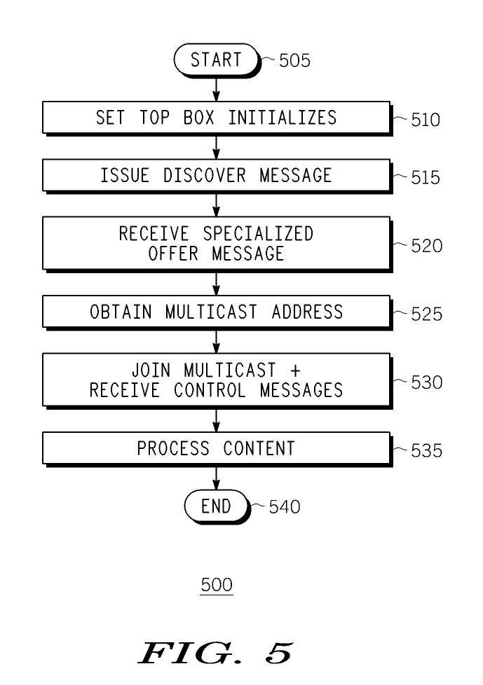

FIG. 5 shows another method 500 for receiving control messages via a multicast. The process begins at step 505. At step 510, set top box 120 is initialized as previously described. At step 515, processor 225 issues a Discover message 305. At step 520, processor 225 receives the Specialized Offer message 310. As previously stated, Specialized Offer message 310 includes the multicast address associated with the control messages. At step 525, processor 225 extracts the multicast address from Specialized Offer 310. At step 530, set top box 120 joins the multicast and begins to receive control messages. At step 535, set top box process the content messages in accordance with the received control messages. The process then ends at step 540.

The processes shown in FIGS. 4 and 5 may be implemented in a general, multi-purpose or single purpose processor. Such a processor will execute instructions, either at the assembly, compiled or machine-level, to perform that process. Those instructions can be written by one of ordinary skill in the art following the description of FIGS. 4 and 5 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. A method for receiving control messages transmitted using a multicast address so as to render content comprising:
retrieving the multicast address from a memory;
using the multicast address to join a multicast;
receiving control messages from the multicast; and
processing content based on the received control messages.

2. The method of claim 2 wherein the processing content further comprises:
decrypting the content using a key embedded in at least one of the control messages.

3. A method for receiving control messages transmitted using a multicast address so as to render content comprising:
retrieving data from a memory;
requesting data that includes a multicast address;
receiving the multicast address;
using the multicast address to join a multicast;
receiving control message from the multicast; and
processing content based on the received control messages.

4. The method of claim 3 wherein the data is an address different from the multicast address.

5. The method of claim 3 wherein the data is a URL.

6. The method of claim 3 wherein the processing content further comprises:
decrypting the content using a key embedded in at least one of the control messages.

7. A method for receiving control message transmitted using a multicast address so as to render content comprising:
issuing a discover request;
receiving an offer wherein the offer includes the multicast address;
using the multicast address to join a multicast;
receiving control message from the multicast; and
processing the content based on the received control messages.

8. The method of claim 7 wherein the processing content further comprises:
decrypting the content using a key embedded in at least one of the control messages.
